(19) United States
(12) Patent Application Publication
(10) Pub. No.: US 2005/0196230 A1
(43) Pub. Date: Sep. 8, 2005

(54) Universal rack mounting connector and assembly

(75) Inventors: William Dubon, Bloomingdale, IL (US); Ronan Stephens, Berwyn, IL (US); Donald Anderson, Oak Park, IL (US)

Correspondence Address: VEDDER PRICE KAUFMAN & KAMMHOLZ, 222 N. LASALLE STREET, CHICAGO, IL, 60601, US

(73) Assignee: Pentair Electronic Packaging Co.

(21) Appl. No.: 11/035,515

(22) Filed: Jan. 14, 2005

Related U.S. Application Data
(60) Provisional application No. 60/537,435, filed on Jan. 16, 2004.

(51) Int. Cl. F16D 1/00

(52) U.S. Cl. 403/327

(57) ABSTRACT

A universal rack mounting connector and assembly includes a base member having a first side and a second side. A plurality of rectangular tabs extend outward from the first side of the base member. A plurality of cylindrical tabs extend outward from a second side of the base member. The second side of the base member further includes a plurality of rectangular footings disposed around the cylindrical tabs. The base member further includes a plurality of apertures for receiving a fastener. The universal connector allows for the disposition of the extending tabs through a back-end of a sliding rail assembly. If the server rack uses rectangular tabs, the universal connector is positioned so the first face engages the back side of the sliding rail assembly. If the server rack uses a cylindrical tabs, the universal connector may be positioned so the second face abuts against the sliding rail assembly.

### BACKGROUND OF THE INVENTION

The present invention relates generally to a universal connector and system and more specifically to a universal connector and assembly for a telescoping sliding rail assembly in a server rack.

A typical server rack system includes a plurality of server racks disposed within a single housing or cabinet. The case contains a computer server disposed between opposing sliding rail assemblies. When the computer server is pulled outward from the server rack, the sliding rails telescope outward to support the computer server.

Under existing manufacturing specifications, the back end of the telescoping rail may be secured using either a first connector or a second connector. Currently, a user must purchase a specific type of sliding rail assembly based on the whether the server rack is a square hole system or a round hole system. As different rack manufacturers have different specifications, telescoping slider rail manufacturers must make both types of sliding rail assemblies commercially available.

A first sliding rail assembly includes a connector with several rectangularly extending tabs. The rectangularly extending tabs engage corresponding rectangular openings within the server rack for secure engagement of the sliding rail assembly to the server rack.

A second sliding rail assembly includes a connection with several cylindrically extending tabs. The connector secures the rail assembly to the server rack by the engagement of the cylindrical tabs with the server rack. The second sliding rail assembly using the round hole system in the server requires a user to install four screws per bracket to secure the sliding rail system to the rack. On a four post enclosure, the user is required to install sixteen screws.

An end user must purchase either the first sliding rail assembly with the rectangularly extending tabs on the second sliding rail assembly with the cylindrically extending tabs because the type of connector is determined by rack manufacturer specifications which are not necessarily consistent with telescoping rail manufacturing specifications. This requires suppliers of slide rail systems to manufacture and sell the first product for installation in square hole server enclosures and manufacture and sell the second sliding rail assemblies for round hole enclosures. This not only increases production costs by requiring the manufacture of two separate types of sliding rail assemblies, but also limits an end user to having to order one particular type of sliding rail assembly.

Therefore, there exists a need for a universal connector capable of allowing for assembly of a sliding rail assembly with a server rack independent of the rack manufacturer assembly specifications.

### SUMMARY OF THE INVENTION

A universal rack mounting connector and assembly includes a base member having a first side and a second side. A plurality of rectangular tabs extend outward from the first side of the base member. A plurality of cylindrical tabs extend outward from the second side of the base member.

In the universal connector, the second side of the base member further includes a plurality of rectangular footings disposed around the cylindrical tabs. The base member further includes a plurality of apertures for receiving a fastener therethrough.

The universal connector allows for the disposition of the extending tabs through a back-end of a sliding rail assembly. If the server rack is designed for rectangular tabs, the universal connector is positioned so the first face engages the back side of the sliding rail assembly, extending the rectangular tabs therethrough. If the server rack utilizes a cylindrical connector, the universal connector may be positioned so the second face abuts against the sliding rail assembly, extending the cylindrical tabs therethrough.

As the sliding rail assembly contains a plurality of rectangular apertures for extending the tabs therethrough, the rectangular footings on the second side of the base element fittingly engage the rectangular apertures of the sliding rail assembly for the secure engagement of the universal connector therein. Also, a plurality of fasteners may be utilized to securingly engage the universal connector to the back side of the sliding rail assembly.

The universal rack mounting connector and system allows for a single slide rail assembly including the universal connector to be utilized with a server rack having the rectangular and cylindrical assembly configurations.

### BRIEF DESCRIPTION OF THE DRAWINGS

FIG. 1 illustrates a perspective view of a universal connector and a portion of a sliding rail assembly;

FIG. 2 illustrates a perspective view of the universal connector engaged within the portion of the sliding rail assembly;

FIG. 3 illustrates a perspective view of the universal connector engaged within the portion of the sliding rail assembly;

FIG. 4 illustrates a perspective view of the universal connector engaged within the portion of the sliding rail assembly; and

FIG. 5 illustrates a perspective view of the universal connector engaged within the portion of the sliding rail assembly.

### DETAILED DESCRIPTION OF A PREFERRED EMBODIMENT

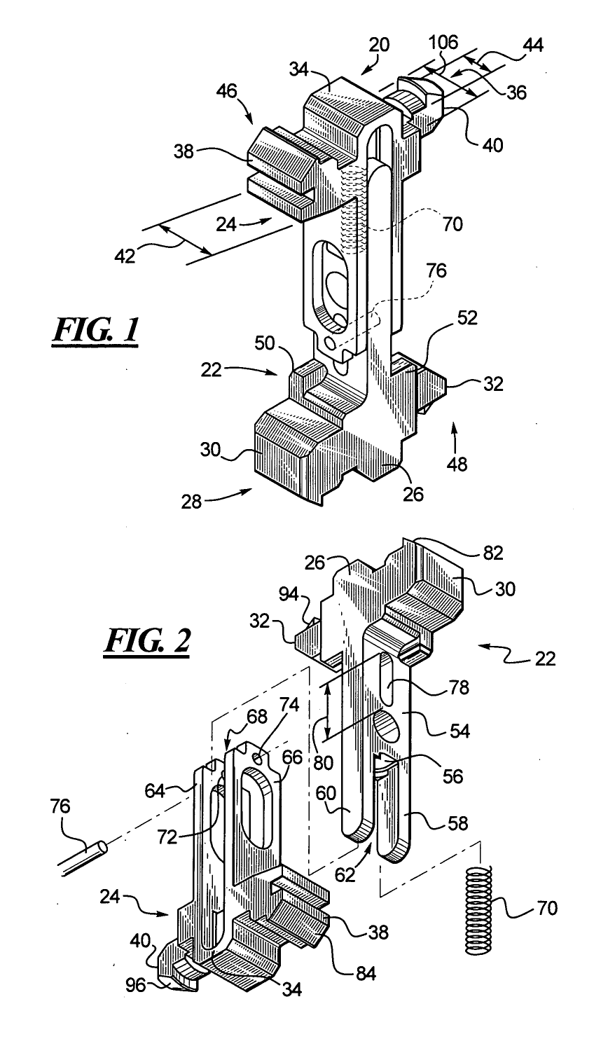

FIG. 1 illustrates a universal connector 100 and a portion of a slide rail assembly 102 for use within a server rack (not shown). The universal connector includes a base member 104 having a first side 106 and a second side 108. Two rectangular tabs 110 extend out from the first side 106. The rectangular tabs 110 are spaced apart a distance equivalent to the distance between corresponding rectangular apertures 112 on the slide rail assembly 102.

Two cylindrical tabs 114 are disposed on the second side 108 of the base member 104. The member 104 includes rectangular footings 116 disposed about the cylindrical tabs 114 on the second side 108. In the preferred embodiment, the rectangular footings 116 have similar length and width dimensions as the rectangular tabs 110 disposed on the first side 106 of the member 104.

The rectangular footings 116 are spaced apart from each other a distance approximately equal to the spacing between the apertures 112 on the rail 102. The cylindrical tabs 114 have a diameter less than the width and less than the height of the apertures 112. The rectangular footings 116 have a height and width approximately equivalent to the height and width of the apertures 112 so that when the connector 100 engages the rail 102, the cylindrical tabs 114 extend through the apertures 112 and the footings 116 contactingly engage the apertures 112.

FIG. 1 further illustrates a preferred embodiment for the secure engagement of the connector 100 to the rail 102 using a fastener (not shown). The connector 100 includes a plurality of fastening apertures 120 disposed between the tabs 110 and the first side 106 and the tabs 114 on the second side 108. Corresponding fastener apertures 122 are disposed on the rail 102. Using a fastener, such as any suitable fastening device such as but not limited to a screw or a bolt, the universal connector 100 can be securingly engaged to the rail 102, having either the rectangular tabs 110 or the cylindrical tabs 114 extending through the apertures 112. As recognized by one having ordinary skill in the art, any other suitable means may be employed to secure the connector 100 to the rail 102, such as but not limited to using an adhesive or epoxy to affix the elements together.

FIG. 2 illustrates a perspective view of the rail 102 with the universal connector 100 engaged with the rail 102. In the embodiment illustrated in FIG. 2, the first face (not visible) contacts with a flange portion 124 of the rail 102. The rectangular tabs 110 extend through the apertures 112 and the fastener apertures 120 on the connector 100 align with the fastener apertures 122 on the rail. Also visible in FIG. 2, the tips of cylindrical tabs 116 are visible as extending out from the second side (not visible).

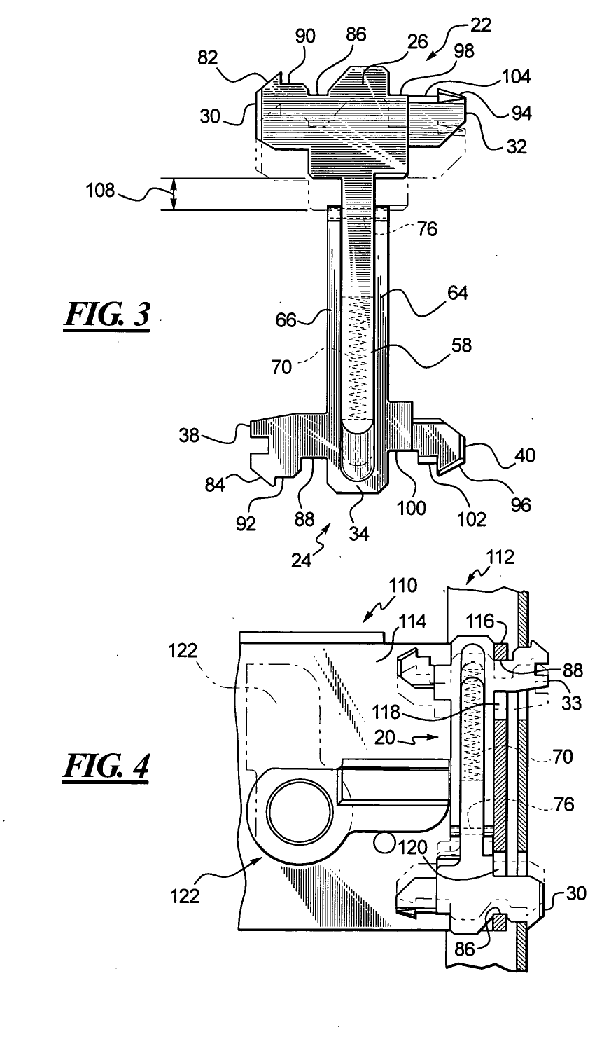

FIG. 3 illustrates a perspective view of the assembly of FIG. 2 from an alternative perspective. The connector 100 extends the cylindrical tabs 110 through the apertures (not visible) and the cylindrical tabs 116 extend towards the interior of the rail 102.

As discussed above, the universal connector 100 allows for assembly of the rail 102 with a server rack having both a square configuration and a circular configuration. FIG. 4 illustrates the other embodiment for implementing the universal connector 100 relative to the rack 102, including the cylindrical tabs 116 extending through the apertures 114. FIG. 4 also illustrates the rectangular footings 116 contactingly engaging the apertures 112. The contact engagement of the footings 116 in the apertures 112 align, the orientation of the connector 100, and more specifically the cylindrical tabs 114.

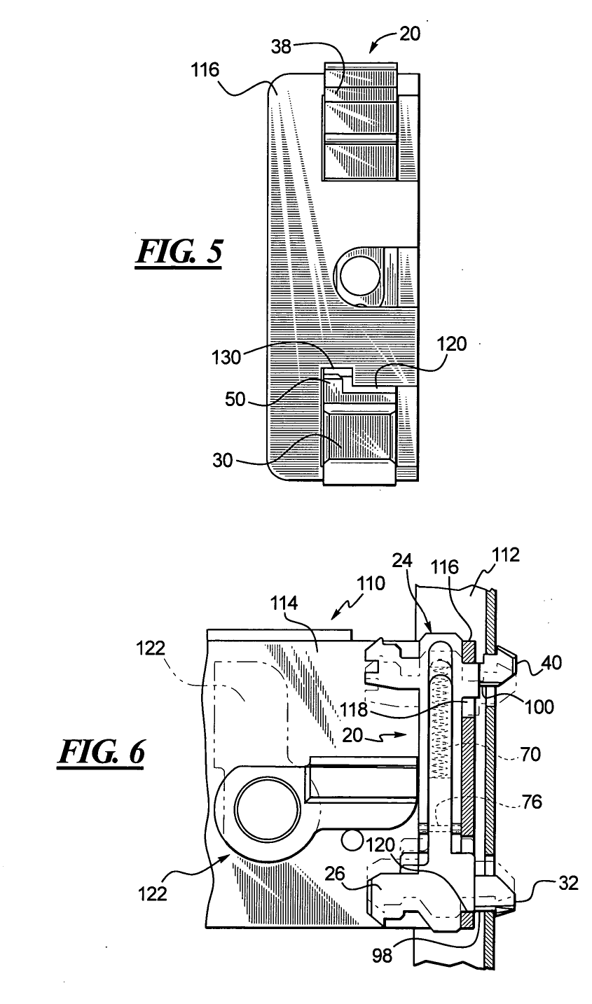

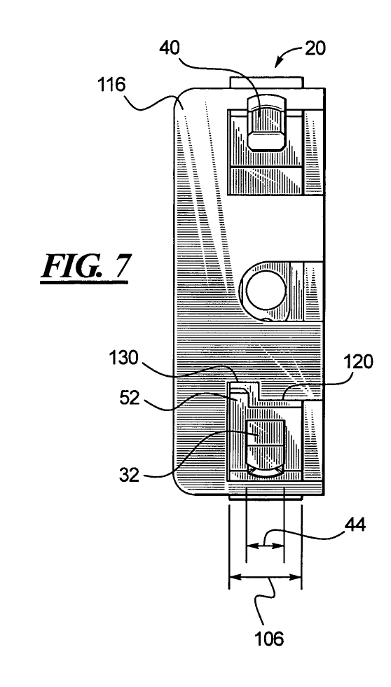

FIG. 5 illustrates the orientation embodiment of FIG. 4 from an alternative perspective of the rack 102, including the connector 100 having the cylindrical tabs 110 extend towards the interior of the sliding rail 102.

Thereupon, the universal connector 100 allows for tabs, either cylindrical 114 or rectangular tabs 110. User may provide, based on the orientation of the connector 100, for automatic installation of a sliding rail assembly 102 to a server rack by securing the connector 100 to a flange portion of the sliding rail 102. Thereupon, the sliding rail may be directly installed within a server rack assembly and provide for support capabilities and the utilization of the telescoping sliding rail systems for support of the platform section.

Upon the engagement of the connector 100 with the rail 102, such that the tabs portions (110 or 114) extend through the apertures 112, the rail 102 may be installed in a server rack in accordance with known assembly techniques. The rails 102 are well known within the industry and any suitable telescoping sliding rail assembly may be utilized for the telescoping aspect of the sliding rail and the sliding rail 102 in the present invention includes the flange 124 or any other suitable mechanism for assembly with the universal connector 100.

Although the invention has been described in detail with reference to certain preferred embodiments, variations and modifications exist within the scope and spirit of the invention as described and defined herein. For example, the tabs 110 and 114 may be any suitable shape in conformance with corresponding receptacles within the server rack, such that the sliding rail assembly is secured therein.

1. A universal connector comprising:
a base member having a first side and a second side;
the first side having a plurality of first connectors extending outward from the first face; and
the second face having a plurality of second connectors extending outward from the second face, wherein the second connectors include a footing portion having height and width dimensions similar to a height and width dimension of the first connector.

2. The universal connector of claim 1 wherein the plurality of first connectors are rectangular tabs and the plurality of second connectors are cylindrical tabs having rectangular footings.

3. A universal connection assembly comprising:
a universal connector including:
a base member having a first side and a second side;
the first side having a plurality of first connectors extending outward from the first face; and
the second face having a plurality of second connectors extending outward from the second face, wherein the second connectors include a footing portion having height and width dimensions similar to a height and width dimension of the first connector; and
a sliding rail assembly having a flange portion with a plurality of apertures such that when the universal connector contactingly engages the flange portion at least one of: the first connector and the second connector extend through the apertures.
